(19) United States
(12) Patent Application Publication
(10) Pub. No.: US 2002/0007350 A1
(43) Pub. Date: Jan. 17, 2002

(54) System and method for on-demand data distribution in a P2P system

(76) Inventor: Brian Yen, Palo Alto, CA (US)

Correspondence Address: Aaron Wininger, Squire, Sanders & Dempsey, L.L.P., 600 Hansen Way, Palo Alto, CA, 94304-1043, US

(21) Appl. No.: 09/900,803

(22) Filed: Jul. 6, 2001

Related U.S. Application Data
(60) Provisional application No. 60/217,788, filed on Jul. 11, 2000.

(51) Int. Cl. G06F 17/60; H04K 1/00; H04L 9/00

(52) U.S. Cl. 705/52; 705/14

(57) ABSTRACT

A system for on demand data distribution includes a distribution engine and an index of distributable data files stored in peers. The distribution engine sends to a requesting peer an address of a peer having a requested data file and an encryption dataset to decrypt the data file. The distribution engine also charges a registered owner of the peer for purchase of the data file and updates the index to indicate that the requesting peer now stores the data file.

### PRIORITY REFERENCE TO PRIOR APPLICATIONS

This application claims benefit of and incorporates by reference provisional patent application Ser. No. 60/217,788, entitled “System and Method for On-Demand Data Distribution,” filed on Jul. 11, 2000, by inventor Brian Yen.

### TECHNICAL FIELD

This invention relates generally to peer-to-peer (“P2P”) data distribution, and more particularly, but not exclusively, provides techniques for encrypted on-demand P2P data distribution and payment.

### BACKGROUND

Conventionally, P2P systems, such as Napster, enable a user to store and share data files, such as MP3 files, on his or her computer. The user may also download data files from other users' computers to his or her computer. The downloaded files may then also be shared with other users. To enable sharing, the user first logs on to a central server, which keeps a registry of all logged-on users and their files available for sharing. The central server notes the address of the user and his/her files that are available and adds the filenames to the registry. If the user wants to download a file, the user enters the filename (i.e., a song's title in the case of Napster) and the central server returns a list of computers storing the file. The user can then download the song from one of the computers.

However, there are disadvantages to conventional P2P systems. One disadvantage may include the lack of a payment technique for downloading files. Another possible disadvantage of conventional P2P systems is that they may enable theft of intellectual property via unauthorized duplication of copyrighted data files.

### SUMMARY

The present invention provides a system for distributing data via a P2P network topography. The system comprises a server communicatively coupled to a network, such as the Internet. A plurality of consumer boxes, which may include mobile devices, computers, or any other network-enabled device (which may also be generically referred to as peers), may also be coupled to the network. The central server includes a distribution engine, which keeps a database of files available over the network at consumer boxes, as well as consumer boxes' addresses. The database also keeps consumer box owner data, which may include name, address, and payment information, as well as other data. Upon receiving a request for a data file from a consumer box, the distribution engine locates a consumer box closest to the requesting consumer box that has the requested data file. The distribution engine then sends information to the requesting consumer box necessary to download the data file from the closest consumer box. This information may include the address of the closest consumer box, encryption data to decrypt the request data file, and other data. The distribution engine may also request payment information from the requesting consumer box and process payment.

The present invention further provides a method for P2P data distribution. The method comprises the steps of receiving a request from a consumer box for a data file, the request including payment information; locating a consumer box closest to the requesting consumer box having the requested file; sending encryption data to decrypt the request data file to the requesting consumer box; sending the address of the closest consumer box to the requesting consumer box; and processing payment for the requested file.

Therefore, the system and method may advantageously prevent theft of intellectual property in P2P systems by enabling encryption and payment for authorized duplication of intellectual property.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a diagram of a network topography suitable for employing an embodiment of the invention;

FIG. 2 is a block diagram of central server of FIG. 1;

FIG. 3 is a block diagram showing the memory of the central server;

FIG. 4 is a block diagram of consumer box 2 of FIG. 1;

FIG. 5 is a block diagram showing the memory of the consumer box 2;

FIG. 6 is a flowchart diagram of a method for a central server communicatively coupled to multiple consumer boxes to distribute data on a P2P system;

FIG. 7 is a flowchart diagram of a method for a consumer box communicatively coupled to the central to distribute data on a P2P system; and

FIG. 8 is a diagram of a network topography suitable for employing an alternative embodiment of the invention.

### DETAILED DESCRIPTION OF THE ILLUSTRATED EMBODIMENTS

The following description is provided to enable any person skilled in the art to make and use the invention, and is provided in the context of a particular application and its requirements. Various modifications to the embodiments will be readily apparent to those skilled in the art, and the generic principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

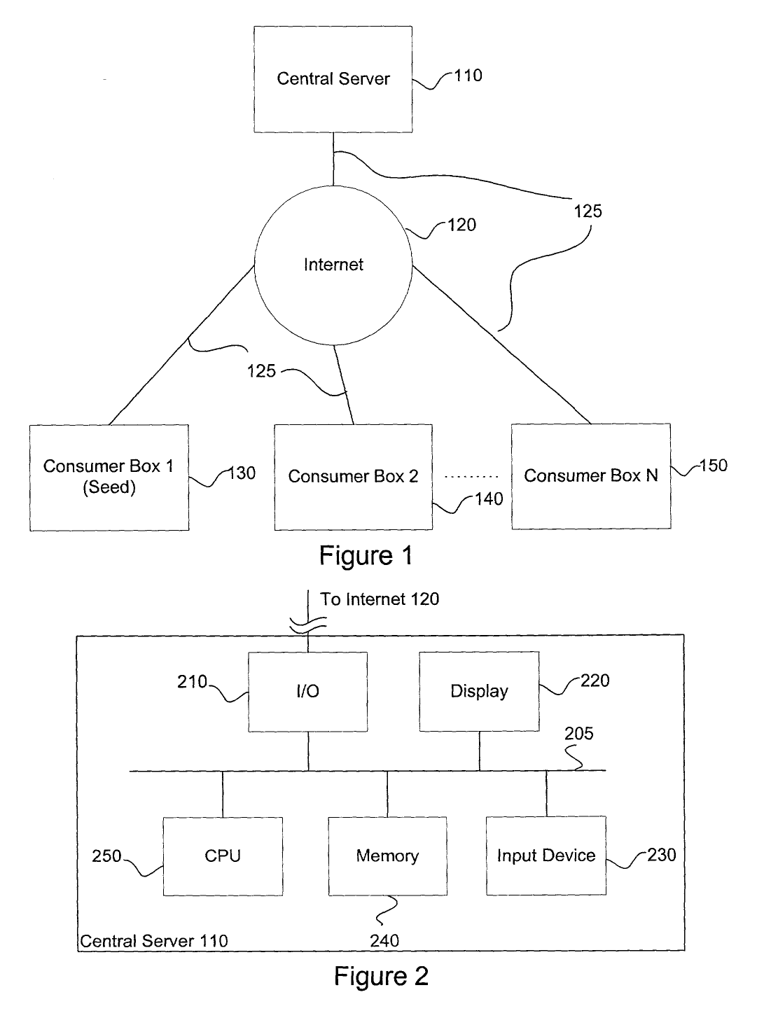

FIG. 1 is a diagram of a network topography suitable for employing an embodiment of the invention. In one embodiment, central server 110, consumer box 1 (130), consumer box 2 (140) and numerous other consumer boxes are communicatively coupled to the Internet 120 via DSL connections 125. In an alternative embodiment, Internet 120 can be any other network suitable for transferring data and DSL connections 125 may be other suitable types of connections to a network such as dial up, cable modem connections, wireless connections or a LAN. Also note that central server 110 can alternatively comprise multiple servers accessible via one net IP address. The multiple servers may in turn be coupled to database servers that are coupled to a single storage array holding an index and other required data for implementing the invention. The storage array may also be mirrored at different locations across the world.

FIG. 2 is a block diagram of central server 110 (FIG. 1). Central server 110 comprises Input/Output (“I/O”) interface 210; display 220; input device 230; memory 240; and CPU 250, all coupled together via system bus 205. I/O 210 couples central server 110 to Internet 120. Input device 230 can comprise a keyboard, mouse, trackball, or other devices or any combination thereof. Memory 240 may comprise a single read and write capable memory device, or it may comprise multiple memory devices including a Hard Drive, RAM, ROM and/or any other memory devices. CPU 250 can be an Intel Pentium® processor or any other processor capable of executing instructions stored in memory 240. In addition, central server 110 may comprise other peripheral devices (not shown).

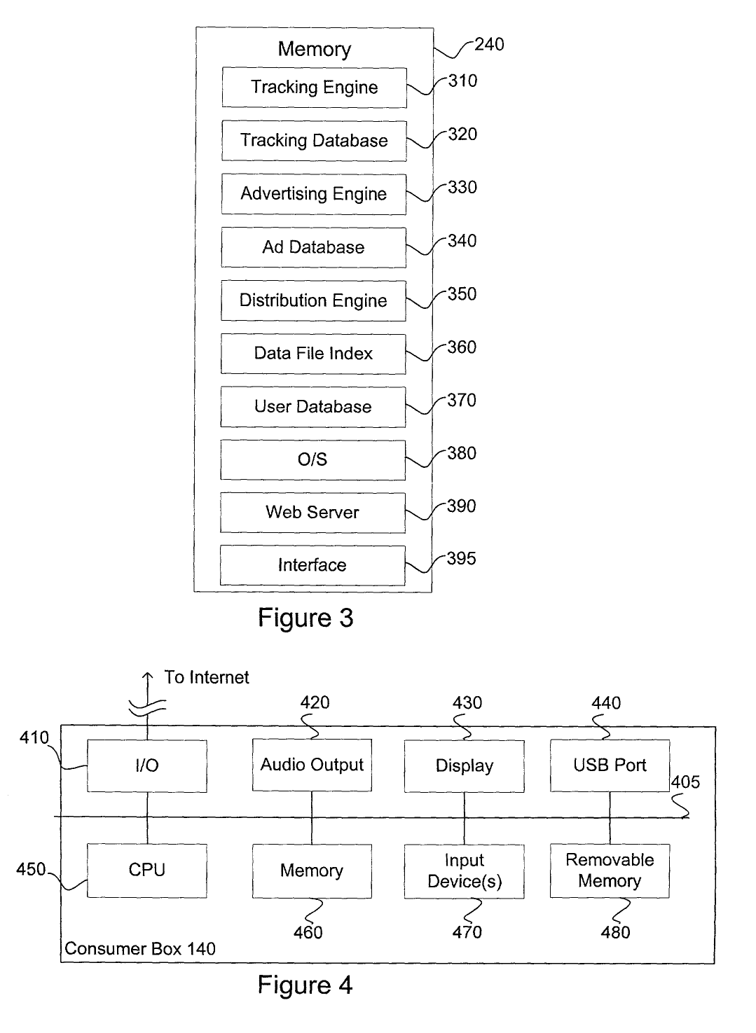

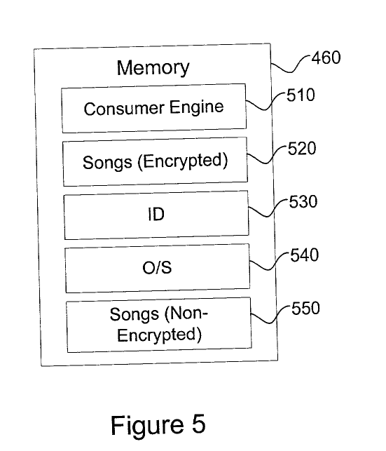

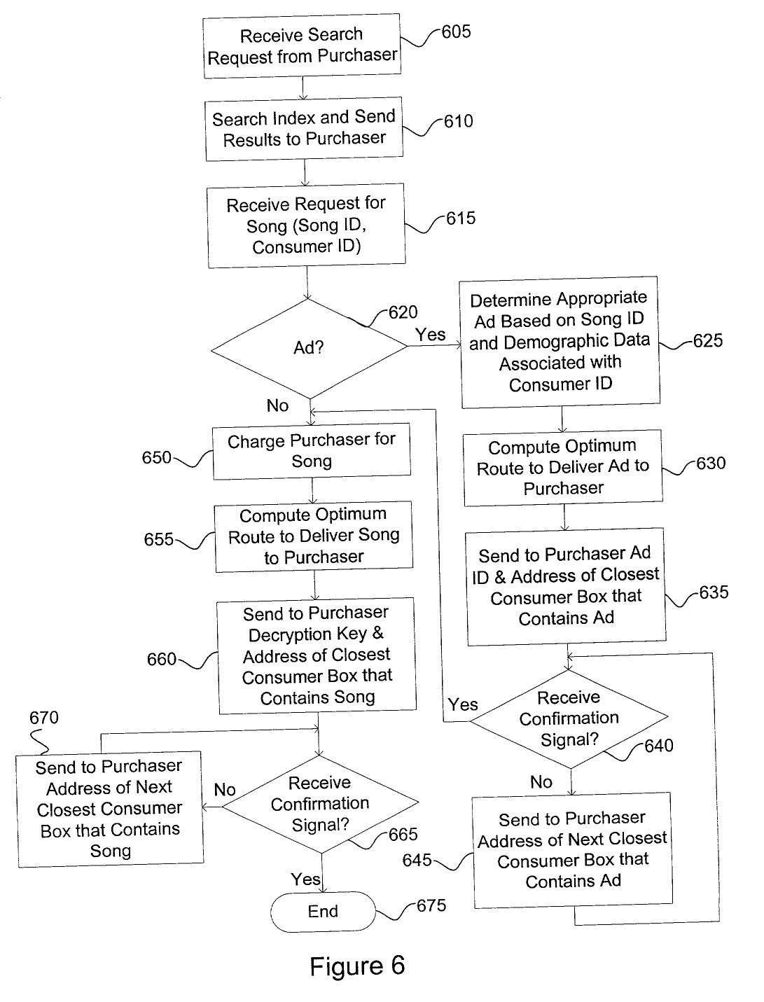

FIG. 3 is a block diagram showing the memory 240 (FIG. 2), which includes tracking engine 310; tracking database 320; advertising engine 330; ad database 340; distribution engine 350; data file index 360; user database 370; operating system (“O/S”) 380; optional web server 390; and optional interface 395. Tracking engine 310 tracks how widely songs are distributed and/or requested and which demographics groups are listening to which songs and then stores this data in tracking database 320. Advertising engine 330 tracks the distribution of ads stored in ad database 340 and in consumer boxes. Distribution engine 350 handles distribution of songs and payment for distribution of songs and will be discussed in further detail in conjunction with FIG. 6. Data file index 360 is an index of available data files (typically MP3 files), their locations (i.e., IP addresses or other address type and ID 530 (FIG. 5) of consumer boxes holding the data file) and the decryption key, if any, for each data file. Identical data files on different consumer boxes may have different decryption keys or identical decryption keys. Note that while in the embodiment discussed herein the data file may include MP3-encoded songs, other embodiments may include any other type of data file such as audio/visual, text, etc. Data file index 360 may also hold the IP addresses or other address-types of ads.

User database 370 includes names of all registered owners of consumer boxes, the IDs of their associated consumer boxes, payment information for the purchase of data files (i.e., debit or credit card information or any other suitable technique for making payment for the purchase of media), and relevant demographic data for use in targeting ads. In one embodiment, O/S 380 is Linux. However, O/S 380 can be any operating system capable of operating with software residing in memory 240. Optionally, memory 240 can also include web server 390 for serving web pages and sending interface 395 to consumer boxes for ordering media.

FIG. 4 is a block diagram of consumer box 2 (140), which may be substantially similar to consumer box 1 (130) and any other consumer boxes or peers communicatively coupled to Internet 120. Consumer box 2 (140) may be an instant-on device (i.e., boot-up time is minimal). Consumer box 2 (140) comprises I/O 410; audio output 420; display 430; CPU 450; memory 460; input device(s) 470; optional Universal Serial Bus (“USB”) port 440 and optional removable memory 480, all coupled together via system bus 405. I/O interface 410 connects consumer box 2 (140) to the Internet 120 so that consumer box 2 (140) can exchange data with other consumer boxes communicatively coupled to the Internet 120 as well as with central server 110.

Audio output 420 may include speakers for outputting songs and ads that are downloaded from other consumer boxes or central server 110. Alternatively, audio output 420 may include headphones or any other device for outputting sound. CPU 450 may include an Intel Pentium® processor or any other processor capable of executing instructions stored in memory 460. Input device 470 may include a keyboard, mouse, or any other device or combination thereof for inputting information. Optional USB port 440 is for communicatively coupling devices, such as an MP3 player, to download songs from memory 460. Note that in another embodiment USB port 440 may alternatively be any type of port for connecting devices. Similarly, songs may be stored in removable memory 480 for listening to in portable devices. Note that only authorized songs stored in memory 460 can be downloaded via USB port 440 or to removable memory 480. Songs may be authorized for downloading by paying additional fees. In addition, songs may be authorized for downloading if the songs are authorized by the copyright owner to be distributed for free (or if the songs are in the public domain).

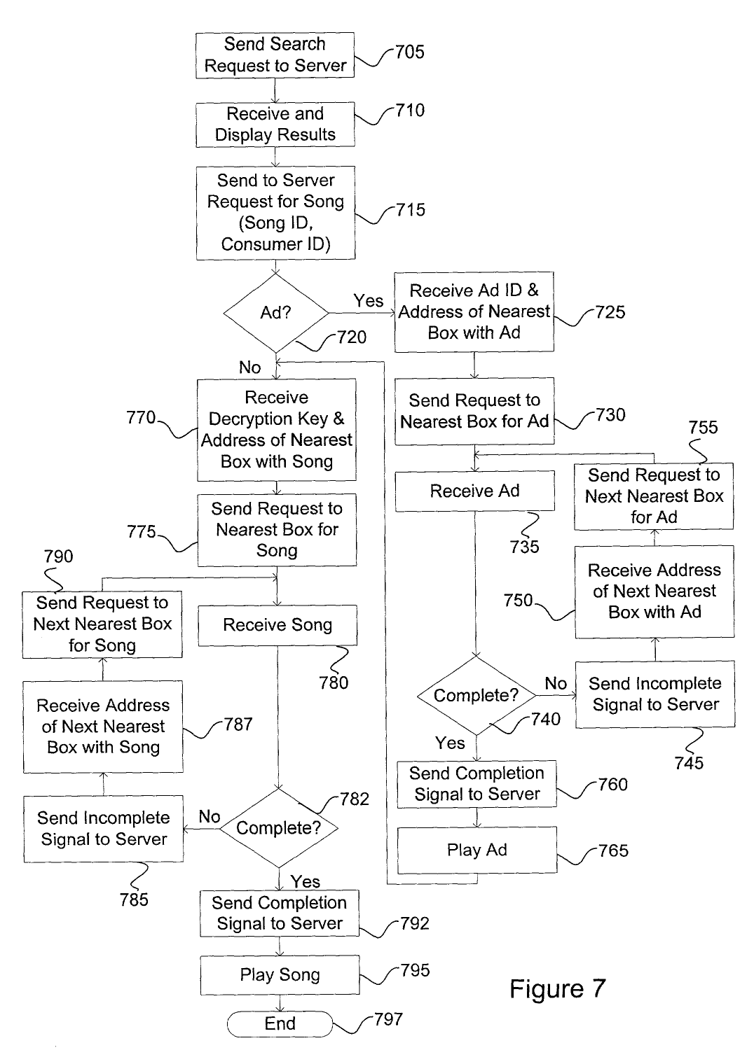

FIG. 5 is a block diagram of memory 460, which comprises consumer engine 510; encrypted songs 520; ID 530; O/S 540; and optional non-encrypted songs 550. Note that memory 460 may also optionally store (or store in place of and perform the operations of consumer engine 510) a client browser, such as Internet Explorer, for surfing Internet 120 and interacting with optional interface 395 (FIG. 3). Consumer engine 510 interacts with the central server 110 to download songs from other consumer boxes. In addition, consumer engine 510 sends songs from songs (encrypted) 520 to other consumer boxes upon receipt of a request for the specified song. Operation of consumer engine 510 will be discussed in further detail in conjunction with FIG. 7.

Songs (encrypted) 520 holds encrypted songs downloaded from other consumer boxes (peers). These songs are typically in MP3 format but can be any format that can be outputted via audio output 420. Further, songs stored in songs (encrypted) 520 can be downloaded to a device, such as an MP3 player, or to removable memory 480, if the songs are authorized for downloading (i.e., by payment of a fee, if they are public domain, or authorized for free distribution, etc.). In an alternative embodiment, songs stored in songs (encrypted) 520 may be downloaded via USB port 440 or to removable memory 480 but are degraded with each duplicate made in order to discourage illegal distribution. Songs (encrypted) 520 may also hold ads in encrypted form (to prevent tampering) for distribution to other consumer boxes.

ID 530 is a unique ID established for each consumer box and relates to the owner of the consumer box. Upon purchasing a consumer box, the purchaser registers the box and may submit relevant demographic information, which can be used for targeting advertisements. Alternatively, submission of demographic information may be optional or not even requested during the registration process. Upon registration, the purchaser establishes an account with central server 110 so that the purchaser may download songs and have his/her credit or debit card (or other payment means) automatically charged for the purchase. The account is identified by ID 530, which is sent to central server 110 whenever a purchaser downloads a song. In an alternative embodiment, consumer box 2 (140) may be a personal computer employing a client browser, such as Internet Explorer. In this case, ID 530 would be a unique ID stored in a cookie in memory 460 by the client upon registering for On-Demand Radio over the Internet.

O/S 540 is an operating system capable of operating with consumer application 510. In one embodiment, O/S 540 may include Linux. However, in an alternative embodiment O/S 540 may be any operating system such as Windows 2000® Palm OS®, etc. Optional songs (non-encrypted) 550 may include songs (or other data files), typically in MP3 format, that are authorized for distribution without payment. As such, the songs need not be encrypted.

FIG. 6 is a flowchart diagram of a method for distributing data on a P2P system. In one embodiment, distribution engine 350 of central server 110 can execute the method of FIG. 6. The method of FIG. 6 may run continuously or at representative intervals. Further, multiple instances of the FIG. 6 method may run simultaneously. Note that in an alternative embodiment, the method of FIG. 6 can be preceded by the sending of interface 395 to a requesting consumer box. First, a search request for songs is received (605) from, in one embodiment, a requesting consumer box or peer, such as consumer box 2 (140), over Internet 120 or other network. Next, an index or database is searched (610), such as index 360, for songs matching search criteria in the search request and results are sent, in one embodiment, to consumer box 2 (140). Next, a request for a specific song from consumer box 2 (140) is received (615). The request may include a song identifier, such as a song title, and a machine identifier, such as ID 530. The request may also include information specifying the type of purchase such as download for a single play, download for a limited number of plays or unlimited play, download to removable memory, etc. Further, the request may include a password or other security data to verify that the user of consumer box 2 (140) is in fact authorized to make this purchase.

Next, it is determined if an ad should be sent (620). The determination can be based on user preferences, song selected, type of purchase made (i.e., purchase may be subsidized or free for listening to an advertisement), etc. In one embodiment of the invention, advertising engine 330 (FIG. 3) performs the determination. If an ad is to be sent to, for example, consumer box 2 (140), then an appropriate ad may be determined (625) based on the song identifier (i.e., ads for entry-level cars may be appropriate for Madonna songs while ads for high-end cars may be more appropriate for classical songs) and/or demographic data associated with the ID 530 (for example, feminine hygiene products would be more appropriate for female consumers than for male consumers) by, in one embodiment, advertising engine 330. Alternatively, an ad may be randomly selected or a default ad may be selected that is not based on demographic data or the song identifier.

Once it is determined which ad to send, then it is determined (630), by, in one embodiment, advertising engine 330, which consumer box holding the determined ad is closest to the requesting consumer box. Determination of the closest consumer box storing the ad can be determined via comparing geographical addresses of consumer boxes holding the ad with the requesting consumer box. Alternatively, consumer boxes may be “pinged” to determine the closest consumer box via the Internet 120. In one embodiment, the determined ad may reside in ad database 340 of central server 110. Further, the ad may be encrypted in order to prevent tampering with the ad.

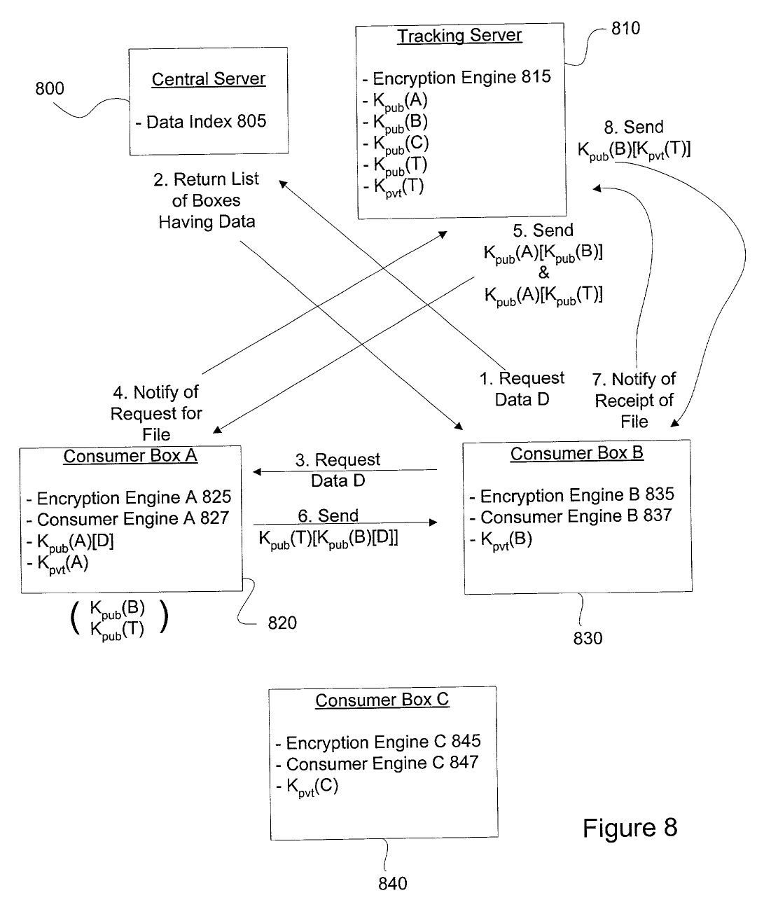

The identifier information of the determined ad and the address of the closest consumer box are sent (635). If the ad is encrypted, then a decryption key may also sent. In an alternative embodiment of the invention, the encryption technique of FIG. 8, as described below, may be used to encrypt and decrypt the ad. If a receipt of ad confirmation signal is received from a requesting box, then an owner of the consumer box requesting the song is charged (650) for the song, as will be discussed further below. If a negative confirmation signal is received (640) or after a pre-specified amount of time has passed without receipt (640) of a signal, then the address of the next closest consumer box that contains the ad is sent (645). If a confirmation signal is not received (640), then the address of the third closest consumer containing the song is sent (645). This process may be repeated until a confirmation signal is received. Alternatively, this process may be repeated a finite number of times or may be repeated for a pre-specified amount of time.

Once a confirmation signal is received (640) or if no ad is to be displayed, the purchaser is charged (650) for the song. Note that if the song is free (public domain, subsidized by ads, etc.) then the purchaser need not be charged. In an alternative embodiment, the purchaser may be charged after receiving (665) a confirmation signal confirming receipt of the song. In one embodiment, distribution engine 350 charges the purchaser for the song by charging a credit card or debit card. Alternatively, distribution engine 350 can debit a prepaid account or debit a checking account or use any other suitable techniques for accepting payment. In an alternative embodiment, distribution engine 350 can bill the purchaser through his or her ISP bill, similarly to the conventional method of billing for purchased services or items to a telephone bill. In one embodiment, payment information for each registered purchaser may be stored in user database 370 and indexed by ID 530 of the consumer box.

Next, the closest consumer box holding the song is computed (655) by either comparing geographical addresses of consumer boxes with the requesting consumer box (as stored in user database 370 in one embodiment), by pinging consumer boxes, or via other techniques. Next, a decryption key for the song requested by the requesting box and the address of the closest consumer box that contains the song is sent (660). In an alternative embodiment of the invention, the encryption technique of FIG. 8, as described below, may be used to encrypt and decrypt the song. If a receipt of song confirmation signal is received (665) then the method ends (675). If a negative confirmation signal is received (665) or after a pre-specified amount of time has passed with no receipt (665) of a signal, then the address of the next closest consumer box that contains the song is sent to the requesting consumer box. Sending (660) addresses and awaiting receipt (665) of confirmation may be repeated until a confirmation signal is received. Repetition may be limited to a pre-specified amount of times in order. Once confirmation is received, the method ends (675).

FIG. 7 is a flowchart diagram of a method for distributing data on a P2P system. In one embodiment, consumer engine 510 of a consumer box can execute the method of FIG. 7. The method of FIG. 7 may run continuously or at representative intervals. Further, multiple instances of the FIG. 7 method may run simultaneously. Note that in one embodiment, the method of FIG. 7 can be preceded by receiving interface 395, in which case, an optional client, such as Internet Explorer, will perform the method of FIG. 7 instead of consumer engine 510.

First, a search request is sent (705) to a central server, such as central server 110. Next, the results of the search from the central server are received and then displayed (710). In one embodiment of the invention, consumer engine 510 may display the results on display 430. Alternatively, the results could be voice synthesized and output via speakers, such as audio output 420. Next, a request that includes a song identifier and ID, such as ID 530, is sent (715) to the central server. In addition, a password or other security data to verify that a user is in fact authorized to make this purchase may be sent to the central server. The request may also include information specifying the type of purchase such as download for a single play, download for a limited number of plays or unlimited play, etc.

If notification is received (720) that no ad is to be played, then a decryption key and address of the closest box having the song is received (770), as will be discussed further below. However, if an ad is to be played, then the address of the nearest box with the ad and an ad identifier is received (725). In one embodiment, the ad may be located in ad database 340 of central server 110, in which case the received address would be that of central server 110. In addition, if the ad is encrypted, a decryption key will also be received. Note that in an alternative embodiment of the invention, the encryption technique of FIG. 8, as described below, may be used to encrypt and decrypt the ad. Next, a request for the ad is sent to the nearest box (or the central server 110 as discussed above). The ad is then received (735).

If the ad is not completely received (740) or if there is another problem receiving the ad (740), then an incomplete signal is sent to central server 110 (745). Then, the address of the next nearest box with the ad is received (750). A request to the address of the next nearest box that was identified in then sent (755). The ad is then received (735). The above process for receiving an ad may be repeated until an ad is received in its entirety. In another embodiment of the invention, the process may be limited to a finite amount of time or number of attempts.

Once the ad is received, a completion signal is sent (760) to central server 100 and then the ad is played (765). Next, a decryption key (if the song is encrypted) and the address of the nearest box containing the song are received (770). Next, a request for the song is sent (775) to the identified box. The request includes the song identifier. The song is then received (780) from the nearest box that contains the song. If the song is not completely received (782) due to some network communication failure or because the nearest box drops offline or some other reason, then an incomplete signal is sent (785) to central server 110. An address of the next nearest box that holds the song is then received (787). A request to the next nearest box (787) is then sent (790). The above process for requesting a song can be repeated until the song is successfully received. In another embodiment of the invention, the process may be limited to a finite amount of attempts or to a finite amount of time.

Once the song is completely received, a completion signal is sent (792) to central server 110. The song is then decrypted with the decryption key and played (795). In another embodiment of the invention, the downloaded song can also be encrypted and stored in songs (encrypted) 520, and inform central server 110 accordingly. In turn, central server 110 will update index 360 to show that the requesting box holds a copy of this song, thereby causing the requesting box to become a server for this song. Note that in an alternative embodiment of the invention, the encryption technique of FIG. 8, as described below, may be used to encrypt and decrypt the song.

FIG. 8 is a diagram of a network topography suitable for employing an alternative embodiment of the invention. The network topography includes a central server 800, a tracking server 810, and consumer boxes 820, 830, and 840, which are all communicatively coupled together via a network, such as the Internet. In an embodiment of the invention, the network topography of FIG. 8 implements an encryption technique that may be used in conjunction with the methods disclosed in FIG. 6 and FIG. 7.

The central server 800, tracking server 810, and consumer boxes 820, 830, and 840 use a public key (asymmetric) encryption technique in order to securely store data files on consumer boxes and to transmit data files between consumer boxes. The public key system utilizes a pair of keys generated with a single algorithm called RSA after the inventors Rivest, Shamir and Adleman, which is described in U.S. Pat. No. 4,405,829, which is hereby incorporated by reference. This algorithm relies on the fact that factorizing very large numbers into two primes is a very hard problem and should take a computer a long time. The basis of the public key system is the two keys, one is kept secret and stored on a consumer box and the other key may be public and is stored on the tracking server 810. Only the private key can decrypt information that is encrypted by a corresponding public key. Therefore, to transmit data, an encryption engine uses the public key stored on the tracking server 810 to encrypt data. Then, only the consumer box having the corresponding private may decipher the data to use it. Further, to protect data for integrity, the data may be checksummed using the private key stored in the consumer box.

Central server 800 may be substantially similar to server 110 (FIG. 1) and includes a data index 805, which may be substantially similar to data file index 360 (FIG. 3). Tracking server 810 may track transactions and also performs encryption using encryption engine 815, as will be discussed further below. In one embodiment of the invention, the features of tracking server 810 may be combined with central server 800, thereby eliminating the need for two servers. Tracking server 810 also stores public keys K_{pub}(A), K_{pub}(B), and K_{pub}(C) for consumer boxes A 820, B 830 and C 840, respectively. In one embodiment, consumer boxes A 820, B 830 and C 840 do not know their respective public keys. Further, for a transaction T, encryption engine 815 may generate public key K_{pub}(T) and private key Kₚᵥₜ(T).

Consumer boxes 820, 830, and 840 may be substantially similar to consumer box 1 (130) (FIG. 1). Consumer box A 820 includes an encrypted data file D. The data file D is encrypted with K_{pub}(A) (referred to herein as K_{pub}(A)[D]) and may be decrypted with Kₚᵥₜ(A), which is stored in memory of consumer box A 820. In one embodiment of the invention, Kₚᵥₜ(A) is hardwired into consumer box A 820 such that it is undiscoverable by a user of consumer box A 820. Consumer box A 820 also includes an encryption engine A 825 to encrypt K_{pub}(A)[D] using public keys received from tracking server 810, as will be discussed further below. Further, consumer box A 820 may also include a consumer engine A 827 for transmitting data between consumer boxes and servers, as will be discussed further below. In one embodiment, consumer engine A 827 may be substantially similar to consumer engine 510 (FIG. 5).

Consumer box B 830 includes an encryption engine B 835 and Kₚᵥₜ(B), which may be hardwired into consumer box B 830 such that it is undiscoverable by a user of box B 830. Kₚᵥₜ(B) is a private key that can decrypt data encrypted with K_{pub}(B). Further, consumer box B 830 may also include a consumer engine B 837 for transmitting data between consumer boxes and servers, as will be discussed further below. In one embodiment, consumer engine B 837 may be substantially similar to consumer engine 510 (FIG. 5).

Consumer box C 840 includes an encryption engine C 845 and Kₚᵥₜ(C), which may be hardwired into consumer box C 840 such that it is undiscoverable by a user of box C 840. Kₚᵥₜ(C) is a private key that can decrypt data encrypted with K_{pub}(C). Further, consumer box C 840 may also includes a consumer engine C 847 for transmitting data between consumer boxes and servers, as will be discussed further below. In one embodiment, consumer engine C 847 may be substantially similar to consumer engine 510 (FIG. 5).

In an example operation of the topology of FIG. 8, box B 830 requests a data file D from central server 800. A distribution engine (not shown), similar to distribution engine 350 (FIG. 3), then searches data index 805 for consumer boxes holding the data file D and returns a list of boxes having D. The list may be in order of closest location, fastest location, or other orders. Note that in the example of FIG. 8, only box A 820 has D. A user of consumer box B 830 then selects a box having D or a consumer engine 837 may automatically select a box based on closest location, expected download time or other criteria. The engine 837 then transmits a data request for D to box A 820. Consumer engine 827 of box A 820 receives the request and may reject it for various reasons including no longer having D, at which point engine 837 must select another box having D, assuming one is available.

Assuming that engine 827 of box A 820 accepts the request, engine A 827 then notifies tracking server 810 of the request. If central server 800 performs the functions of tracking server 810, then the request may go to central server 800 instead. The request may include an address of consumer box A 820 and an ID of the consumer box requesting the data D. In turn, encryption engine 815 of tracking server 810 generates K_{pub}(T) and Kₚᵥₜ(T) using techniques described in U.S. Pat. No. 4,405,829. In addition, encryption engine encrypts K_{pub}(B) and K_{pub}(T) using K_{pub}(A) yielding K_{pub}(A)[K_{pub}(B)] and K_{pub}(A)[K_{pub}(T)] and sends them to consumer box A 820.

Encryption engine A 825 then decrypts the encrypted keys K_{pub}(A)[K_{pub}(B)] & K_{pub}(A)[K_{pub}(T)] using Kₚᵥₜ(A) to get K_{pub}(B) and K_{pub}(T). Encryption engine A 825 then decrypts K_{pub}(A)[D] using Kₚᵥₜ(A) to get unencrypted D. Encryption engine A 825 then encrypts D with K_{pub}(B) and K_{pub}(T) to yield K_{pub}(T)[K_{pub}(B)[D]] or K_{pub}(B)[K_{pub}(T)[D]] depending on the order of encryption. Consumer engine A 827 then transmits K_{pub}(T)[K_{pub}(B)[D]] (or K_{pub}(B)[K_{pub}(T)[D]]) to consumer box B 830.

Upon receipt of K_{pub}(T)[K_{pub}(B)[D]] at consumer box B 830, consumer engine B 837 notifies tracking server 810 of receipt of the encrypted data D. Encryption engine 815 of tracking server 810 then encrypts Kₚᵥₜ(T) with K_{pub}(B) to yield K_{pub}(B)[Kₚᵥₜ(T)], which encryption engine 815 then sends to consumer box B 830. Encryption engine 835 then decrypts K_{pub}(B)[Kₚᵥₜ(T)] using Kₚᵥₜ(B) to yield private key Kₚᵥₜ(T). Encryption engine 835 then decrypts the encrypted D-K_{pub}(T)[K_{pub}(B)[D]] using Kₚᵥₜ(T) and Kₚᵥₜ(B) to yield unencrypted D, which can then be played on consumer box 830. Further, K_{pub}(B)[D] may be stored in consumer box 830. After decryption, consumer engine B 837 notifies central server 800 that the transaction is completed and can then charge the registered owner of box B 830 per the method of FIG. 6. In an alternative embodiment, central server 800 may charge the register owner of box B 830 at initiation of the transaction or at another point. In addition, consumer engine B 837 may notify central server 800 to update data index 805 to include that box B 830 now stores D.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method for implementation in an index server in a peer-to-peer system, comprising:
receiving, from a first peer, a request for a data file, the request including an ID of the first peer;
identifying a second peer having the data file from an index of peers;
processing payment for the data file; and
sending, to the first peer, an address of the second peer and a first encryption dataset to decrypt the data file.

2. The method of claim 1, wherein the identifying identifies a second peer geographically closest to the first peer.

3. The method of claim 1, wherein the identifying identifies a second peer having a lowest number of pings in relation to the first peer.

4. The method of claim 1, wherein the data file is a music file.

5. The method of claim 1, further comprising:
selecting an advertisement to send to the first peer; and
sending, to the first peer, an address of a peer having the advertisement.

6. The method of claim 5, wherein the selecting an advertisement is based on demographic data associated with the first peer.

7. The method of claim 5, wherein the processing payment processes a reduced payment for the data file upon sending, to the first peer, the address of a peer having the advertisement.

8. The method of claim 1, further comprising verifying a password from the first peer before processing payment and sending, to the first peer, the address of the second peer.

9. The method of claim 1, wherein the processing does not occur until receipt, from the first peer, of a confirmation signal confirming receipt of the data file.

10. The method of claim 1, further comprising:
upon receipt, from the first peer, of a signal indicating inability to retrieve the data file
identifying another peer having the data file from an index of peers;
sending, to the first peer, an address of the another peer and another encryption dataset to decrypt the data file.

11. The method of claim 1, further comprising updating the index of peers to indicate that the first peer includes a copy of the data file.

12. The method of claim 1, further comprising sending a second encryption dataset to the second peer.

13. The method of claim 12, wherein the second encryption dataset includes an encrypted public transaction key and an encrypted public key, the public key capable to encrypt data so that the encrypted data is decipherable only by the first peer.

14. The method of claim 1, wherein the first encryption dataset includes an encrypted private transaction key.

15. The method of claim 14, wherein the encrypted private transaction key is decipherable only by the first peer.

16. A machine-readable medium, for use in an index server in a peer-to-peer system, the server having stored thereon instructions to:
receive, from a first peer, a request for a data file, the request including an ID of the first peer;
identify a second peer having the data file from an index of peers;
process payment for the data file based on the ID of the first peer; and
send, to the first peer, an address of the second peer and a first encryption dataset to decrypt the data file.

17. The machine-readable medium of claim 16, wherein the instruction to identifying identifies a second peer geographically closest to the first peer.

18. The machine-readable medium of claim 16, wherein the instruction to identify identifies a second peer having a lowest number of pings in relation to the first peer.

19. The machine-readable medium of claim 16, wherein the data file is a music file.

20. The machine-readable medium of claim 16, further comprising instructions to:
select an advertisement to send to the first peer; and
send, to the first peer, an address of a peer having the advertisement.

21. The machine-readable medium of claim 20, wherein the instruction to select an advertisement is based on demographic data associated with the first peer.

22. The machine-readable medium of claim 20, wherein the instruction to process payment processes a reduced payment for the data file upon sending, to the first peer, the address of a peer having the advertisement.

23. The machine-readable medium of claim 16, further comprising an instruction to verify a password from the first peer before processing payment and sending, to the first peer, the address of the second peer.

24. The machine-readable medium of claim 16, wherein the instruction to process does not occur until receipt, from the first peer, of a confirmation signal confirming receipt of the data file.

25. The machine-readable medium of claim 16, further comprising instructions to,
upon receipt, from the first peer, of a signal indicating inability to retrieve the data file,
identify another peer having the data file from the index of peers;
send, to the first peer, an address of the another peer and another encryption dataset to decrypt the data file.

26. The machine-readable medium of claim 16, further comprising an instruction to update the index of peers to indicate that the first peer includes a copy of the data file.

27. The machine-readable medium of claim 16, further comprising an instruction to send a second encryption dataset to the second peer.

28. The machine-readable medium of claim 27, wherein the second encryption dataset includes an encrypted public transaction key and an encrypted public key, the public key capable to encrypt data so that the encrypted data is decipherable only by the first peer.

29. The machine-readable medium of claim 16, wherein the first encryption dataset includes an encrypted private transaction key.

30. The machine-readable medium of claim 29, wherein the encrypted private transaction key is decipherable only by the first peer.

31. An index server for use in a peer-to-peer system, comprising:
means for receiving, from a first peer, a request for a data file, the request including an ID of the first peer;
means for identifying a second peer having the data file from an index of peers;
means for processing payment for the data file based on the ID of the first peer; and
means for sending, to the first peer, an address of the second peer and decryption information to decrypt the data file.

32. An index server for use in a peer-to-peer system, comprising:
a data file index capable to store listings of data files, peers storing the data files, and encryption data needed to decrypt the data files;
a distribution engine, communicatively coupled to the index, capable to
receive, from a first peer, a request for a data file, the request including an ID of the first peer;
identify a second peer having the data file from the index;
process payment for the data file based on the ID of the first peer; and
send, to the first peer, an address of the second peer and a first encryption dataset to decrypt the data file.

33. The server of claim 32, wherein the distribution engine is further capable to identify a second peer that is geographically closest to the first peer.

34. The server of claim 32, wherein distribution engine is further capable to identify a second peer having a lowest number of pings in relation to the first peer.

35. The server of claim 32, wherein the data file is a music file.

36. The server of claim 32, wherein the distribution engine is further capable to:
select an advertisement to send to the first peer; and
send, to the first peer, an address of a peer having the advertisement.

37. The server of claim 36, wherein the distribution engine is further capable to select an advertisement based on demographic data associated with the first peer.

38. The server of claim 36, wherein the distribution engine is further capable to process a reduced payment for the data file upon sending, to the first peer, the address of a peer having the advertisement.

39. The server of claim 32, wherein the distribution engine is further capable to verify a password from the first peer before processing payment and sending, to the first peer, the address of the second peer.

40. The server of claim 32, wherein the distribution engine is further capable to delay processing until receipt, from the first peer, of a confirmation signal confirming receipt of the data file.

41. The server of claim 32, wherein the distribution engine is further capable to,
upon receipt, from the first peer, of a signal indicating inability to retrieve the data file,
identify another peer having the data file from the index; and
send, to the first peer, an address of the another peer and another encryption dataset to decrypt the data file.

42. The server of claim 32, wherein the distribution engine is further capable to update the index to indicate that the first peer includes a copy of the data file.

43. The server of claim 32, wherein the distribution engine is further capable to update the index to indicate that the first peer includes a copy of the data file.

44. The server of claim 32, wherein the distribution engine is further capable to send a second encryption dataset to the second peer.

45. The server of claim 44, wherein the second encryption dataset includes an encrypted public transaction key and an encrypted public key, the public key capable to encrypt data so that the encrypted data is decipherable only by the first peer.

46. The server of claim 32, wherein the first encryption dataset includes an encrypted private transaction key.

47. The server of claim 36, wherein the encrypted private transaction key is decipherable only by the first peer.

48. A method for implementation in a first peer in a peer-to-peer system, comprising:
sending, to a server, a purchase request for a data file, the purchase request including a peer identifier;
receiving, from the server, an address of a second peer having the data file and a first encryption dataset for decrypting the data file;
sending, to the second peer, a download request for the data file;
receiving, from the second peer, the data file;
decrypting the data file with the first encryption dataset; and
outputting the data file.

49. The method of claim 48, wherein the data file is a music file.

50. The method of claim 48, further comprising:
receiving, from the server, an address of a peer having an advertisement;
downloading, from the peer having the advertisement, the advertisement; and
playing the advertisement.

51. The method of claim 48, further comprising sending a password to the server before receiving the address of a second peer having the data file and the first encryption dataset for decrypting the data file.

52. The method of claim 48, further comprising sending, to the server, a confirmation signal confirming receipt of the data file.

53. The method of claim 48, further comprising sending, to the server, a signal indicating inability to download the data file when unable to download the data file.

54. The method of claim 53, further comprising receiving an address of a third peer having the data file after sending the signal indicating inability to download the data file.

55. The method of claim 48, wherein the first encryption dataset includes an encrypted private transaction key.

56. The method of claim 55, wherein the encrypted private transaction key is decipherable only by the first peer.

57. The method of claim 55, decrypting the data file using the private transaction key and a private key only known to the first peer.

58. The method of claim 48, further comprising:
storing an encrypted copy of the data file; and
notifying the server that the data file is stored.

59. A machine-readable medium, for use in a peer in a peer-to-peer system, the peer having stored thereon instructions to:
send, to a server, a purchase request for a data file, the purchase request including a peer identifier;
receive, from the server, an address of a second peer having the data file and a first encryption dataset for decrypting the data file;
send, to the second peer, a download request for the data file;
receive, from the second peer, the data file;
decrypt the data file with the first encryption dataset; and
output the data file.

60. The machine-readable medium of claim 59, wherein the data file is a music file.

61. The machine-readable medium of claim 59, further comprising instructions to:
receive, from the server, an address of a peer having an advertisement;
download, from the peer having the advertisement, the advertisement; and
play the advertisement.

62. The machine-readable medium of claim 59, further comprising an instruction to send a password to the server before receiving the address of a second peer having the data file and the first encryption dataset for decrypting the data file.

63. The machine-readable medium of claim 59, further comprising an instruction to send, to the server, a confirmation signal confirming receipt of the data file.

64. The machine-readable medium of claim 59, further comprising an instruction to send, to the server, a signal indicating inability to download the data file when unable to download the data file.

65. The machine-readable medium of claim 64, further comprising an instruction to receive an address of a third peer having the data file after sending the signal indicating inability to download the data file.

66. The machine-readable medium of claim 59, wherein the first encryption dataset includes an encrypted private transaction key.

67. The machine-readable medium of claim 66, wherein the encrypted private transaction key is decipherable only by the first peer.

68. The machine-readable medium of claim 66, wherein the instruction to decrypt the data file further uses a private key known only to the first peer.

69. The machine-readable medium of claim 59, further comprising:
storing an encrypted copy of the data file; and
notifying the server that the data file is stored.

70. A peer in a peer-to-peer system, comprising:
a peer identification; and
an engine capable to
send, to a server, a purchase request for a data file, the purchase request including a peer identifier;
receive, from the server, an address of a second peer having the data file and a first encryption dataset for decrypting the data file;
send, to the second peer, a download request for the data file;
receive, from the second peer, the data file;
decrypt the data file with the first encryption dataset; and
output the data file.

71. The peer of claim 70, wherein the data file is a music file.

72. The peer of claim 70, wherein the engine is further capable to:
receive, from the server, an address of a peer having an advertisement;
download, from the peer having the advertisement, the advertisement; and
play the advertisement.

73. The peer of claim 70, wherein the engine is further capable to send a password to the server before receiving the address of a second peer having the data file and the first encryption dataset for decrypting the data file.

74. The peer of claim 70, wherein the engine is further capable to send, to the server, a confirmation signal confirming receipt of the data file.

75. The peer of claim 70, wherein the engine is further capable to send, to the server, a signal indicating inability to download the data file when unable to download the data file.

76. The peer of claim 75, wherein the engine is further capable to receive an address of a third peer having the data file after sending the signal indicating inability to download the data file.

77. The peer of claim 70, wherein the first encryption dataset includes an encrypted private transaction key.

78. The peer of claim 77, wherein the encrypted private transaction key is decipherable only by the first peer.

79. The peer of claim 77, wherein the engine is further capable to decrypt the data file using the private transaction key and a private key known only to the first peer.

80. The peer of claim 70, further comprising:
storing an encrypted copy of the data file; and
notifying the server that the data file is stored.

81. A peer for use in a peer-to-peer system, the peer comprising:
means for sending, to a server, a purchase request for a data file, the purchase request including a peer identifier;
means for receiving, from the server, an address of a second peer having the data file and a first encryption dataset for decrypting the data file;
means for sending, to the second peer, a download request for the data file;
means for receiving, from the second peer, the data file;
means for decrypting the data file with the first encryption dataset; and
means for outputting the data file.
